(19) United States
(12) Patent Application Publication
(10) Pub. No.: US 2014/0031115 A1
(43) Pub. Date: Jan. 30, 2014

(54) SERVER APPARATUS FOR PROVIDING GAME

(71) Applicants: Megumi Tanabe, Tokyo (JP); Takahiro Yamaguchi, Tokyo (JP); Yuuki Ikuta, Tokyo (JP)

(72) Inventors: Megumi Tanabe, Tokyo (JP); Takahiro Yamaguchi, Tokyo (JP); Yuuki Ikuta, Tokyo (JP)

(21) Appl. No.: 13/748,529

(22) Filed: Jan. 23, 2013

(30) Foreign Application Priority Data
Jul. 30, 2012 (JP) 2012-168831

(51) Int. Cl. A63F 13/12

(52) U.S. Cl. CPC A63F 13/12
USPC 463/31

(57) ABSTRACT

A server device according to one embodiment of the present invention provides a game to client devices via a network. The server device comprises: a receiving unit configured to receive an event determination request including game character specifying information that specifies specific game characters selected by a player from game characters included in a game screen; an event occurrence determination unit configured to determine whether a certain event occurs to each of the specific game characters; and a reward-providing unit configured to provide a reward to the player when it is determined that the certain event occurs to two or more of the specific game characters.

### CROSS-REFERENCE TO RELATED APPLICATIONS

This application is based on and claims the benefit of priority from Japanese Patent Application Serial No. 2012-168831 (filed on Jul. 30, 2012), the contents of which are hereby incorporated by reference in their entirety.

### TECHNICAL FIELD

The present invention is related to a server device for providing a game and a method for providing a game using a computer.

### BACKGROUND

Among various social games, farm simulation games have been popular wherein a player manages a virtual farm allocated to the player. In general, a farm simulation game involves simulation of various activities in actual farms, such as seeding of crops, watering, harvesting, sales of harvested crops, and use and purchase of farming tools. Many of such games include functions for encouraging interactions between players such as exchanging messages with other players. Famous farm simulation games are “Farm Ville” produced by Zynga Game Network, Inc. (see “FarmVille,” [online], Zynga Game Network, Inc., [searched on Jul. 27, 2012], the Internet

<http://apps.facebook.comionthefarm/?redirecting_zy_session_expired=1&>) and “Nouen Hokkorina” produced by the Applicant (see “Nouen Hokkorina,” [online], DeNA Co., Ltd., [searched on Jul. 27, 2012], the Internet <http://www.facebook.com/Hokkorina?_from=fb_fm>).

In some farm simulation games, animal-like game characters may appear in the farm of a player. Such game characters are displayed in the game screen, for example, in relation to a crop when the crop has become harvestable. In some farm simulation games, a player can provide (or “release”) an animal to the farm of another player so as to encourage interaction between the players. In many farm simulation games, a player is rewarded with in-game currency, etc. when “capturing” a game character which has appeared in the farm. Generally, whether or not a “capture” of a game character is successful is randomly determined based on a predetermined probability. In determination of whether a “capture” is successful, the applied probability may be varied in accordance with the game item such as a capture net selected by the user.

### SUMMARY

In conventional farm simulation games, a player is provided with a reward based on the total number of the animals captured by the player. In this case, the only reasonable strategy to maximize the reward for the player is to capture an animal which has appeared in the farm of the player as soon as possible. Thus, conventional farm simulation games allow only one strategy for players with respect to capture of appearing game characters; therefore, such games are monotonous and boring with respect to capture of game characters.

Such a problem is not limited to farm simulation games but is common to any games wherein whether or not an event (e.g., capture) related to a game character appearing in the game space is successful is determined based on the operation on the game character, and the player is provided with a reward in accordance with the result of the determination. In other words, the strategy for acquiring a reward is limited and thus interest is lacking in games wherein whether or not a certain event related to a game character selected by a player occurs is determined, and the player is provided with a reward when the event occurs.

Various embodiments of the present invention provide server devices and game programs that can enhance the strategic characteristics for acquiring a reward in games wherein a player is provided with a reward when a certain event occurs in accordance with the operation by the player on a game character.

A server device according to an embodiment of the present invention is a server device for providing a game to a client device via a network, comprising: a receiving unit configured to receive an event determination request including game character specifying information for specifying one or more specific game characters selected, in accordance with an operation by a player on the client device, from one or more game characters included in the game screen displayed on the client device; an event occurrence determination unit configured to determine, in response to receipt of the event determination request, whether a certain event occurs to each of the one or more specific game characters specified by the game character specifying information; and a reward-providing unit configured to provide a reward to the player when it is determined that the event occurs to two or more of the specific game characters specified by the game character specifying information.

Thus, by means of a server device according to an embodiment of the present invention, a player is provided with a reward when it is determined that a certain event (e.g., capture of a game character) occurs to two or more of the specific game characters selected by the player. It should be noted that the player is provided with a reward when a certain event occurs to two or more game characters in response to one event determination request. In an embodiment of the present invention, a player may be provided with a reward when an event occurs to only one game character in response to one event determination request; however, such a reward is different from the reward of the present invention provided when an event occurs to two or more game characters in response to one event determination request.

Thus, the player is provided with a reward in response to the event occurring to two or more game characters selected by the player, so that the player can take various strategies for acquiring the reward. For example, if the probability that a capture event occurs to a game character is 1/3, and the player selects two game characters for capture, then the probability that a capture event occurs to two or more game characters (that is, the probability of acquiring a reward) is 1/9 (=3/27). Further, if the player selects three game characters for capture, the probability that a capture event occurs to two or more game characters among these three selected game characters is 7/27; if the player selects four game characters for capture, the probability that a capture event occurs to two or more game characters among these four selected game characters is 11/27. Thus, as the number of game characters selected by the player is larger, the probability of acquiring a reward is higher. Meanwhile, to select multiple game characters for capture, the player is required to wait until multiple game characters appear in the game space. Accordingly, the player can take more various strategies as compared to conventional games. For example, the player can either select two game characters upon display of the two game characters or wait for the appearance of a third or later game characters and select three or more game characters. As described above, the probability of acquiring a reward is varied with the number of selected game characters; therefore, the player should make a strategic judgment of the number of the game characters to be selected for a capture event. Additionally, when multiple game characters appear in a game screen, the probability of acquiring a reward is high; therefore, the player is urged to take actions to increase the number of characters displayed in the game screen.

In an embodiment of the present invention, the occurrence probability of an event for a game character may be varied in accordance with game items selected by the player. The game items include an electronic capture net, a capture trap, and other various game items. For example, the occurrence probability of an event for a game character may be 1/3 for the case where no game items are used, 2/3 for the case where a capture net is used, or 1/1 (100%) for the case where a capture trap is used Thus, various occurrence probabilities are applied in accordance with the game item selected by the player, so that the player can take various strategies for acquiring a reward. For example, when the player has a game item that increases the occurrence probability of an event, the probability of acquiring a reward is high even if a small number of game characters appear in the game screen; therefore, it is a reasonable strategy to select two game characters and do not wait for the appearance of a third and later game characters.

A method according to an embodiment of the present invention is a method of providing a game by using a computer, the method comprising the steps of: determining one or more game characters to be displayed in a game screen; causing the computer to display the game screen; generating game character specifying information for specifying one or more specific game characters selected, in accordance with an operation by a player on the computer, from one or more game characters included in the game screen displayed on the computer; in response to the generation of the game character specifying information, determining whether a certain event occurs to each of the one or more specific game characters specified by the game character specifying information; and providing a reward to the player when it is determined that the event occurs to two or more of the specific game characters specified by the game character specifying information.

Various embodiments of the present invention provide server devices and game programs that can enhance the strategies for acquiring a reward in games wherein a player is provided with a reward when a certain event occurs in accordance with the operation by the player on a game character.

### BRIEF DESCRIPTION OF THE DRAWINGS

FIG. 1 is a block diagram schematically illustrating the architecture of a server device according to an embodiment of the present invention.

FIG. 2 is a block diagram schematically illustrating the architecture of a client device connected to the server device according to the embodiment of the present invention.

FIG. 3 is a block diagram illustrating the functionality of the server device according to the embodiment of the present invention.

FIG. 4 shows an example of a game screen displayed on the client device in the embodiment of the present invention.

FIG. 5 is a flow diagram schematically illustrating a process of determining a reward to a player according to the embodiment of the present invention.

FIG. 6 shows an example of a game screen displayed on the client device in the embodiment of the present invention.

FIG. 7 is a block diagram illustrating the functionality of a client device according to another embodiment of the present invention.

FIG. 8 is a flow diagram schematically illustrating a process of determining a reward to a player according to the other embodiment of the present invention.

### DESCRIPTION OF EXAMPLE EMBODIMENTS

Some embodiments of the present invention will be described hereinafter with reference to the drawings. In the drawings, the same components are denoted by the same reference numerals.

FIG. 1 is a block diagram schematically illustrating a game system according to an embodiment of the present invention. As illustrated in FIG. 1, in an embodiment of the present disclosure, an online game server device 10 (hereinafter also referred to simply as the “server device 10”) is communicatively connected to a plurality of client devices 30-1, 30-2, . . . , and 30-N (hereinafter also collectively referred to as the “client devices 30”), each having a communication function, via a communication network 20 such as the Internet.

As illustrated in FIG. 1, the server device 10 includes a central processing unit (CPU) 11, a main memory 12, a user interface (I/F) 13, a communication I/F 14, an external memory 15, and a disk drive 16, and these components are electrically connected to one another via a bus 17. The CPU 11 loads an operating system and various programs for controlling the progress of an online game into the main memory 12 from the external memory 15, and executes commands included in the loaded programs. The main memory 12 is used to store a program to be executed by the CPU 11, and is formed of, for example, a dynamic random access memory (DRAM).

The user I/F 13 includes, for example, an information input device such as a keyboard or a mouse for accepting an input from an operator, and an information output device such as a liquid crystal display for outputting calculation results of the CPU 11. The communication I/F 14 is implemented as hardware, firmware, or communication software such as a transmission control protocol/Internet protocol (TCP/IP) driver or a point-to-point protocol (PPP) driver, or a combination thereof, and is configured to be able to communicate with the client devices 30 via the communication network 20.

The external memory 15 is formed of, for example, a magnetic disk drive and stores various programs such as a control program for controlling the progress of an online game. The external memory 15 also stores various data used in the game. Some or all of the data stored in the external memory 15 may be stored on a database server communicatably connected to the server device 10 and physically separate from the server device 10.

The disk drive 16 reads data stored in a storage medium such as a compact disc read only memory (CD-ROM), digital versatile disc read only memory (DVD-ROM), or DVD Recordable (DVD-R) disc, or writes data to such a storage medium. For example, a game application and data such as game data stored in a storage medium are read by the disk drive 16, and are installed into the external memory 15.

In an embodiment, the server device 10 is a web server for managing a web site including a plurality of hierarchical web pages and is capable of providing the client devices 30 with game services. The client devices 30 are provided with browser software that fetches and analyzes HTML data for rendering a web page to present the web page to a user (a player of the game) of the client devices 30. A game provided through a web page rendered by such browser software is sometimes called a browser game. The HTML data for rendering the web page may also be stored on the external memory 15. HTML data comprises HTML documents written in markup languages such as HTML; the HTML documents can be associated with various images by using tags. Additionally, the HTML documents can include programs written in script languages such as ActionScript™ and JavaScript™

The external memory 15 may store game applications to be executed on execution environments of the client device 30 other than browser software. This game application may include game programs for performing a game and various data such as image data to be referred to for executing the game programs. The game programs are created in, for example, object oriented languages such as Objective-C™ and Java™. The created game programs are stored on the external memory 15 in the form of application software along with various data. The application software stored on the external memory 15 is delivered to a client device 30 in response to a delivery request. The application software delivered from the server device 10 is received by the client device 30 through a communication I/F 34 in accordance with the control of CPU31; the received game programs are sent to an external memory 35 and stored thereon. The application software is launched in accordance with the player's operation on the client device 30 and is executed on a platform implemented on the client device 30 such as NgCore™ or Android™. The server device 10 provides the game applications executed on the client devices 30 with various data required for progression of the games. Additionally, the server device 10 can store various data sent from the client device 30 for each player, thereby managing the progression of the game for each player.

Thus, the server device 10 manages the web site for providing game services and delivers web pages constituting the web site in response to a request from the client device 30, thereby progressing the game. Further, the server device 10 sends and receives various data used in the game to and from the game application executed on the client device 30, thereby progressing the game. Whichever mode is taken to provide the game, the server device 10 can store data required to progress the game for each identification identifying a player (described later). The games provided by the server device 10 includes desired games such as farm simulation games, action games, roll playing games, interactive baseball games, and card games. The types of the games implemented by the web site or game applications of the server device 10 are not limited to those explicitly described herein.

In an embodiment, the client device 30 is a desired information processing device capable of rendering, on a web browser, web pages of a game web site fetched from the server device 10; for example, the client device 30 may be a mobile phone, smart phone, game console, personal computer, touch pad, or electronic book reader, but is not limited thereto. In another embodiment, the client device 30 is a desired information processing device including an application execution environment for executing a game application.

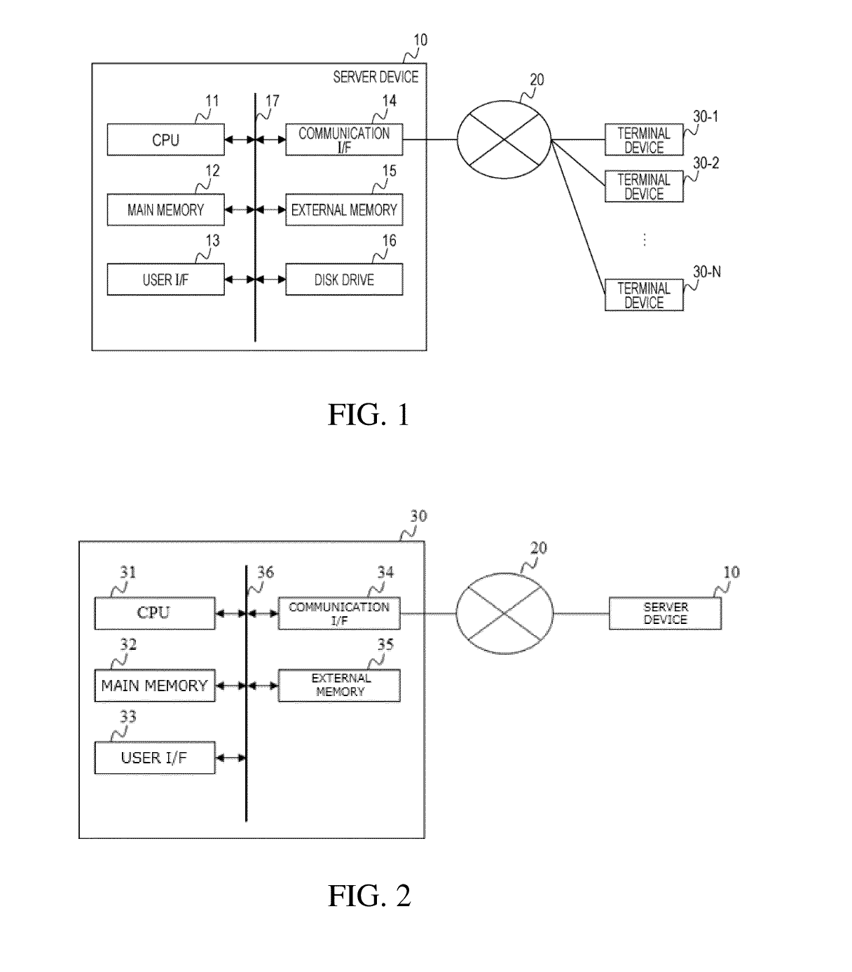

An architecture of the client device 30 will be described below with reference to FIG. 2. FIG. 2 is a block diagram schematically illustrating the architecture of a client device 30. As illustrated in FIG. 2, the client device 30 includes a central processing unit (CPU) 31, a main memory 32, a user interface (I/F) 33, a communication I/F 34, and an external memory 35, and these components are electrically connected to one another via a bus 36.

The CPU 31 loads various programs such as an operating system into the main memory 32 from the external memory 35, and executes commands included in the loaded programs. The main memory 32 stores a program to be executed by the CPU 31, and is formed of, for example, a dynamic random access memory (DRAM).

The user I/F 33 includes, for example, an information input device such as a touch panel, a keyboard, a button, and a mouse for accepting an input from a player (user), and an information output device such as a liquid crystal display for outputting calculation results of the CPU 31. The communication I/F 34 is implemented as hardware, firmware, or communication software such as a transmission control protocol/Internet protocol (TCP/IP) driver or a point-to-point protocol (PPP) driver, or a combination thereof, and is configured to be able to communicate with the server device 10 via the communication network 20.

The external memory 35 comprises, for example, a magnetic disk drive or a flash memory and stores various programs such as an operating system. When receiving a game application from the server device 10 via the communication I/F 34, the external memory 35 stores the received game application.

A client device 30 having such an architecture includes browser software for interpreting and rendering an HTML file (HTML data) for example; this browser software enables the client device 30 to interpret the HTML data fetched from the server device 10 and render web pages corresponding to the received HTML data. Further, in an embodiment, the client device 30 includes plug-in software (e.g., Flash Player distributed by Adobe Systems Incorporated) (FLASH is a trademark) embedded into browser software; therefore, the client device 30 can fetch from the server device 10 a SWF file embedded in HTML data and execute the SWF file by using the browser software and the plug-in software.

When a game is executed, for example, animation or an operation icon designated by the program is displayed on a screen of the client device 30. The player may enter an instruction for causing the game to progress using an input interface (e.g., a touch screen or a button) of the client device 30. The instruction entered by the player is transmitted to the server device 10 through the browser of the client device 30 or a platform such as NgCore™.

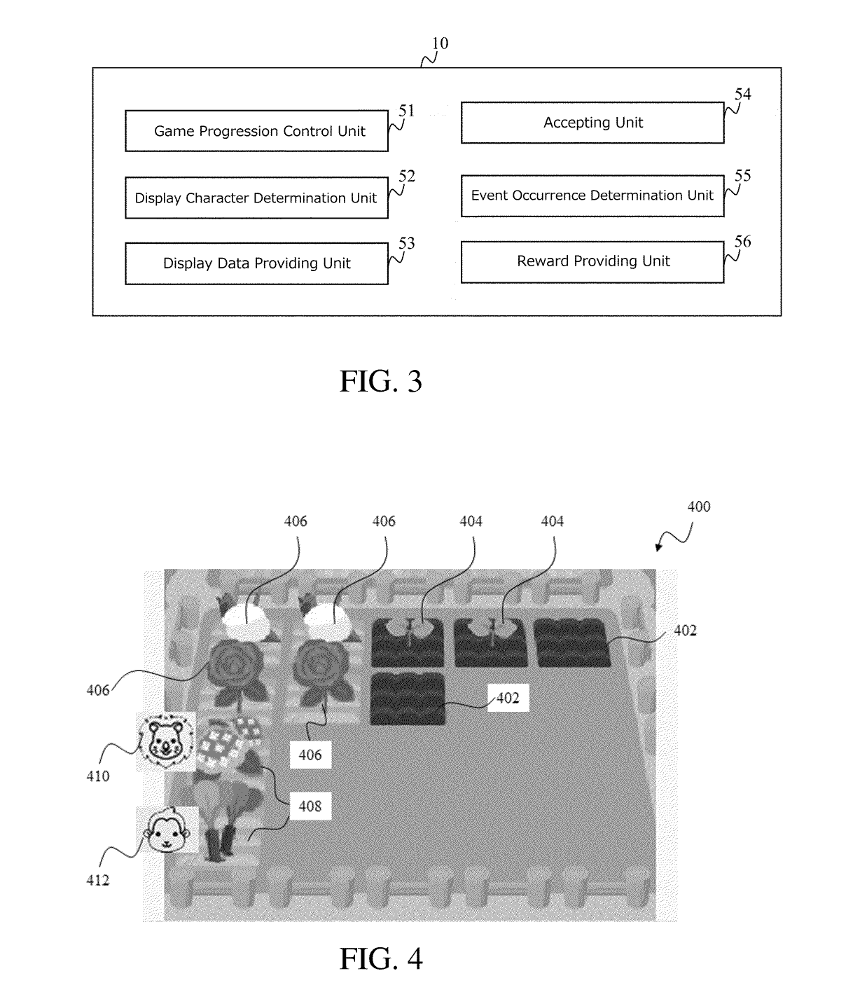

Next, the functionality of the server device 10 implemented by the components shown in FIG. 1 will be described with reference to FIG. 3. FIG. 3 is a block diagram illustrating the functionality of a server device 10 according to an embodiment of the present invention. As shown in FIG. 3, the server device 10 according to the embodiment includes a game progression control unit 51, a display character determination unit 52, a display data providing unit 53, a receiving unit 54, an event occurrence determination unit 55, and a reward-providing unit 56. The server device 10 may include an authentication unit configured to authenticate a player in starting a game, a charging unit configured to charge the player in progression of the game, and/or other desired functions necessary for the progression of the game; detailed description is omitted for these components. Part of the functions shown in FIG. 3 may be omitted. These functions are implemented by the CPU 11 controlling the loading of a certain program onto a main memory 12 and performing operations based on the instructions in the program.

The game progression control unit 51 sends and receives various data required for the progression of the game to and from the client device 30 and manages such data for each player, thereby controlling the progression of the game for each player. For example, the game progression control unit 51 can sequentially send, to the client device 30, web pages constituting a web site for providing game services in response to a request from the client device 30. More specifically, HTML data corresponding to the request from the client device 30 is sent to the client device 30; the client device 30 interprets the HTML data; and a web page corresponding to the HTML data is displayed on the display provided to the client device 30. When a hyperlink on the web page displayed on the client device 30 is selected by the player, the game progression control unit 51 sends new HTML data corresponding to the hyperlink to the client device 30. The client device 30 displays a web page based on the new HTML data. Thus, web pages stored on the server device 10 are sequentially provided to the client device 30 in accordance with the operation by the player; and the player can progress the game by operating the client device 30. Additionally, the game progression control unit 51 fetches from the client device 30 various information related to the progression of the game, such as information indicating various parameter values used in the game (the number of game points earned and information concerning obtained items and crops planted in the farm) and stores the fetched information on, e.g., the external memory 15 in a readable manner. Thus, the game progression control unit 51 appropriately reads out information required for the progression of the game from the external memory 15 to perform control based on the information.

When the client device 30 executes the game application, the game progression control unit 51 can send various data used in the game to the game application. Additionally, the client device 30 can appropriately send various information on the progression of the game to the server device 10 through the browser software and the game application.

The game progression control unit 51 stores, for each player, information on the progression of the game received from a plurality of client devices 30, thereby controlling the progression of the game for each player. Thus, when the player logs in the server device 10 using his own ID, the game is resumed from the scene corresponding to the progression for the player (e.g., the scene where the game was interrupted) based on the information on the progression of the game associated with the player stored in the server device 10. As will be described later, the information required for the progression of the game may be managed by various functions of the server device 10 other than the game progression control unit 51.

The server device 10 provides the client devices 30 with various games. One example of the games that can be performed in the present invention and are provided by the server device 10 is a farm simulation game. As described above, a farm simulation game involves simulation of various activities in an actual farm such as seeding of crops, watering, harvesting, sales of harvested crops, breeding of livestock, and/or purchase of farming tools. In conventional farm simulation games, each player is allocated with a farm of a certain size. The farm is divided into a plurality of sections, and a player can plant crops and trees in each section. The crops and trees grow with time, and become harvestable after predetermined time period assigned to each crop or tree. The player can acquire a reward such as game points by harvesting the harvestable crops or fruits grown on the trees. Each section in a farm can contain not only harvestable objects but a fence, a decorative monument, and/or other structures. The Applicant provides a farm simulation game named “Nouen Hokkorina” on Mobage™ platform.

The server device 10 allows simultaneous accesses from a plurality of client devices 30. Thus, the server device 10 can simultaneously provide a plurality of client devices 30 with the same game. The players playing the same game can mutually interact by using, e.g., a message function implemented in the game. When the server device 10 provides a farm simulation game, a player can provide (release) a game character captured in his own farm to the farm of another player. Thus, the player can interact with other players by providing a game character.

In an embodiment of the present invention, a game screen displayed on the client device 30 can contain one or more game characters. FIG. 4 shows an example of a game screen displayed on the client device 30 when the present invention is applied to a farm simulation game. As shown in the figure, the game screen 400 represents a simulated farm divided into four rows by five columns of sections. A player operates the client device 30 to select a desired section and performs seeding of crops, watering, harvesting, and/or other simulated farm work in the selected section. In FIG. 4, the section 402 has been cultivated but has no crops planted In this cultivated section 402, a seed or seedling of crops, flowers, or trees can be planted (hereinafter “crops, etc.”). The section 404 has just been planted with a crop in the form of a seedling. The seedling grows and becomes harvestable a certain time period after planting. The section 406 has a harvestable crop.

“A game character” described herein represents a desired electronic character displayed in a game screen. The animal-like characters displayed in the game screen of the above farm simulation game are mere examples of game characters used in the present invention. The game characters may include electronic cards used in card games.

In an embodiment of the present invention, a game character is displayed in association with part of harvestable crops. The embodiment shown in FIG. 4 contains game characters 410 and 412 displayed in association with harvestable crops in the section 408. A game that can be performed in the present invention is configured to display two or more game characters in a game screen. The animal-like game characters 410 and 412 shown in FIG. 4 are examples of game characters, and the game characters in this specification are not limited to those shown in FIG. 4. The game characters can take various forms in accordance with the content and the vision of the game. The game characters can be displayed in desired modes selectable by the player through operation of the client device 30.

Each of the game characters has various attributes to be set. The attributes of the game characters are managed by the server device 10. The attributes of the game characters include information indicating the type of the game character (e.g., information specifying the type of an animal, such as a squirrel, monkey, bird, and mole, when the game character is an animal), information indicating the color of the game character displayed in the game screen (e.g., blue-based, red-based, or yellow-based), and/or sex of the game character (e.g., information specifying whether the game character is male or female, when the game character is an animal). The attributes applicable to the present invention are not limited to these attributes.

The one or more game characters displayed in the game screen are determined by the display character determination unit 52. Each of the game characters has an appearance condition set thereto; when an appearance condition is satisfied, the display character determination unit 52 determines the game character to be displayed in the game screen in accordance with the satisfied appearance condition. For example, an appearance condition may be that a specific crop (e.g., a pumpkin) becomes harvestable. The specific crop may be a crop obtained by growing a seed obtained when receiving a game character from another player. The display character determination unit 52 can determine, for example, whether to display a game character in a game screen based on an appearance probability set to the game character when the appearance condition of the game character is satisfied. Additionally, the display character determination unit 52 can also determine the section in the farm in which to display a game character.

In an embodiment, the display character determination unit 52 can determine to display a game character provided by another player in a game screen. For example, when the server device 10 receives a request from player A to provide player B with a specific game character, the display character determination unit 52 determines, based on the request, to display the game character provided by player A in the game screen of player B. In this specification, a game character provided by one player to another player may be called “an interaction game character.”

A display data providing unit 53 can provide the client device 30 with display data for displaying a game character determined by the display character determination unit 52. The display data may include, for example, identification information for identifying a game character to be displayed in the game screen, information for designating a display position of the game character in the game screen, and/or other information required to display the game character in the game screen. The display data for displaying the game character may be either provided to the client device 30 in association with a component of the game screen other than a game character (e.g., an image of a fence placed in the boundary of the farm in the example shown in FIG. 4) or provided independently of such a component.

When a client device 30 obtains display data for displaying a game character from the server device 10, the client device 30 displays the game character in the game screen based on the obtained display data. For example, as shown in FIG. 4, two game characters 410 and 412 are displayed in the game screen based on the obtained display data. The player can operate the client device 30 to select and “capture” both or one of the two game characters 410 and 412. More specifically, the game characters 410 and 412 are selected in response to touching by the player on an area of the display of the client device 30 where the game characters are displayed. The game characters are selected through various input devices other than a touch panel provided to the client device 30.

In this specification, among game characters displayed on the client device 30, a game character selected by the player may be called “a specific game character.” For example, in the example shown in FIG. 4, the game character 410 is the specific game character when the player selects only the game character 410; both game characters 410 and 412 are the specific game characters when the player selects both game characters 410 and 412.

The player can select a game item that affects the occurrence probability of an event for the specific game character by operating the client device 30 in association with the selected specific game character. The game item may be selected, for example, before selection of a game character, simultaneously with selection of a game character, or after selection of a game character. The game item may be, for example, a capture net or a capture trap. As will be described later, when a game item is selected in association with a specific game character, an occurrence probability of an event corresponding to the game item selected for the specific game character is applied

When one or more game characters are selected and the selection is confirmed, a game character specifying information for specifying the selected one or more specific game character is generated through the functions of the client device 30 and the software executed on the client device 30. The game character specifying information can include identification information for identifying the selected specific game character. The client device 30 can send to the server device 10 an event determination request including the game character specifying information (or associated with the game character specifying information). The event determination request may include player identification information of the player playing the game using the client device 30. The player identification information is a desired identification code for identifying a player of the game. Further, when a player selects a game item, the event determination request may include game item identification information for identifying a game item associated with the specific game character.

The server device 10 can receive, from the client device 30, an event determination request including the game character specifying information (or associated with the game character specifying information) through a communication I/F 14. The event determination request is received by a receiving unit 54.

The event occurrence determination unit 55 determines whether or not an event such as capture occurs to each of the specific game characters specified by the game character specifying information included in the event determination request (or associated with the event determination request), in response to the receipt of the event determination request by the receiving unit 54. This determination is performed based on, for example, the event occurrence probability set for each game character. For example, the event occurrence probability for the game character 410 is set at 1/3. The event occurrence probability set for each game character can be desirably determined by the developer or provider of the game in accordance with various factors such as strategic characteristics of the game. The event occurrence determination unit 55 performs determination by using, for example, pseudorandom numbers such that the occurrence probability of an event for each game character agrees with the event occurrence probability set for the game character. In an embodiment, the determination of whether or not an event occurs is performed for each event determination request received by the receiving unit 54. For example, when the receiving unit 54 receives an event determination request including game character specifying information for specifying n (n is a desired natural number) game characters, it is determined whether the event occurs to each of the n game characters.

When the event determination request includes a game item identification information, the event occurrence determination unit 55 varies the event occurrence probability set for each of the game characters in accordance with the game item identification information and determines whether an event occurs to the game character in accordance with the varied event occurrence probability. For example, as stated above, the event occurrence probability for each game character may be 1/3 for the case where no game items are used, 2/3 for the case where a certain game item (e.g., a capture net) is used, or 1/1 (100%) for the case where another game item (e.g., a capture trap) is used The event occurrence probabilities explicitly stated herein are mere examples and can be desirably set.

A reward-providing unit 56 determines whether a predetermined reward-providing conditions are satisfied in accordance with the result of determination of event occurrence to each game character made by the event occurrence determination unit 55 and, when the conditions are satisfied, the reward-providing unit 56 provides a reward to the player who sent the event determination request. The reward thus provided to the player is stored on the server device 10 in association with the identification information of the player. Alternatively, the information stored in association with the player is updated in accordance with the provided reward. For example, when a player A is rewarded with 1,000 game points, 1,000 points are added to the game points stored in association with the player identification information of the player A.

In one embodiment, a reward-providing condition is that it is determined that a predetermined event (e.g., capture) occurs to each of two or more of the specific game characters specified by game character specifying information included in one event determination request. For example, when game character specifying information included in one event determination request specifies two game characters, the reward-providing condition is satisfied when it is determined that the event occurs to each of the two game characters. For another example, when game character specifying information included in one event determination request specifies three game characters, the reward-providing condition is satisfied when it is determined that the event occurs to each of two or more (two or three) of the three game characters.

In another embodiment, the reward-providing unit 56 determines whether to provide a reward to a player based further on the attributes of a game character to which an event is determined to occur by the event occurrence determination unit 55. More specifically, when the event occurrence determination unit 55 determines that an event occurs to two or more game characters, it is determined whether to provide a reward to a player in accordance with combination of attributes of the game character to which the event is determined to occur. In this case, the reward-providing condition may be, for example, that all of the plurality of game characters to which the event is determined to occur are (1) the same type of animals, (2) different types of animals, (3) displayed in the same color, (4) displayed in different colors, and/or (5) interaction game characters. In another embodiment, the reward-providing condition may be, for example, that at least two of the game characters to which the event is determined to occur are (1) the same type of animals, (2) different types of animals, (3) displayed in the same color, (4) displayed in different colors, and/or (5) interaction game characters. Further, the reward-providing conditions in still another embodiment may be that a plurality of game characters to which the event is determined to occur include the same type of male and female animals (for example, the case where it is determined that the event occurs to both male and female squirrels). The reward-providing conditions described herein are mere examples; and the reward-providing conditions may include desired conditions that enhance the strategic characteristics in acquiring a reward and do not depart from the purport of the present invention.

When determining that the reward-providing conditions are satisfied based on one event determination request, the reward-providing unit 56 determines to provide a reward to a player who sent the event determination request. The rewards to be provided includes, for example, game points usable in the game, an electronic object usable in the game, and platform-common points commonly usable in a platform on which the game is performed (e.g., Mobage™ provided by the Applicant); but the rewards applicable to the present invention are not limited thereto. When a reward-providing condition is satisfied, the reward-providing unit 56 may provide a certain reward (e.g., game points) irrespective of which reward-providing condition is satisfied In another embodiment, the reward-providing unit 56 may provide different rewards in accordance with the satisfied reward-providing condition. For example, when a plurality of game characters to which an event is determined to occur include the same type of male and female animals, an electronic object representing a brace of the animal may be provided to the player. The player can install the object in his own farm for decoration.

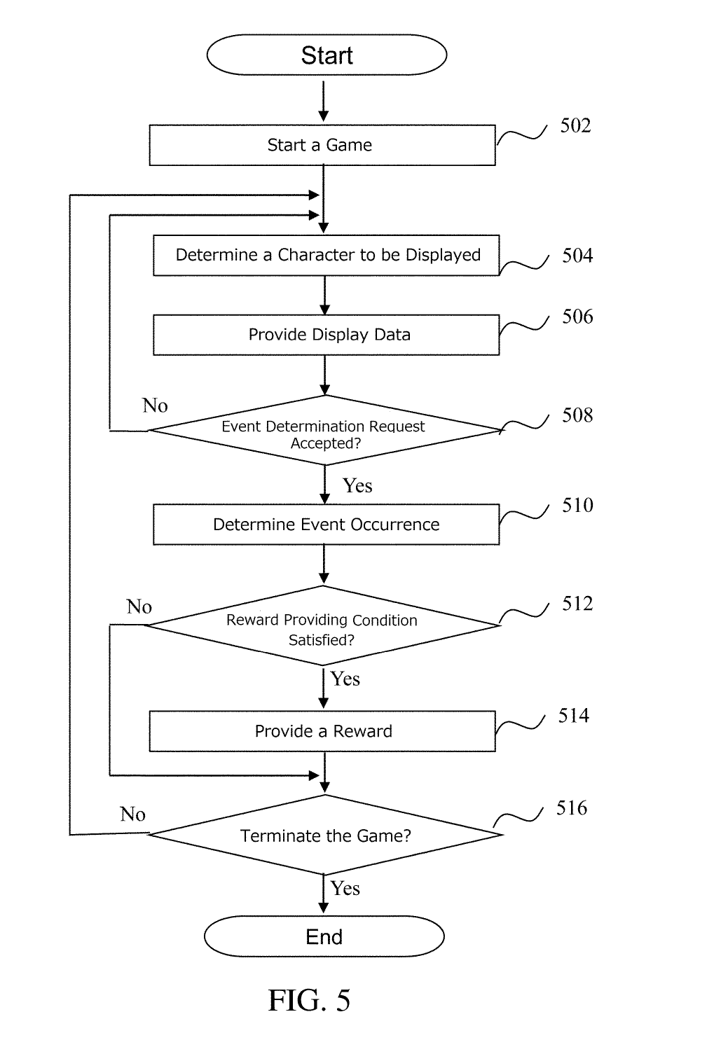

Next, an example of reward-providing process in an embodiment of the present invention will be described below with reference to FIG. 5. FIG. 5 is a flow diagram schematically showing the process from the start of the game to the determination of a reward provided to the player. In FIG. 5, a farm simulation game is provided by a server device 10 as a browser game, and the process will be described for a player A playing the game.

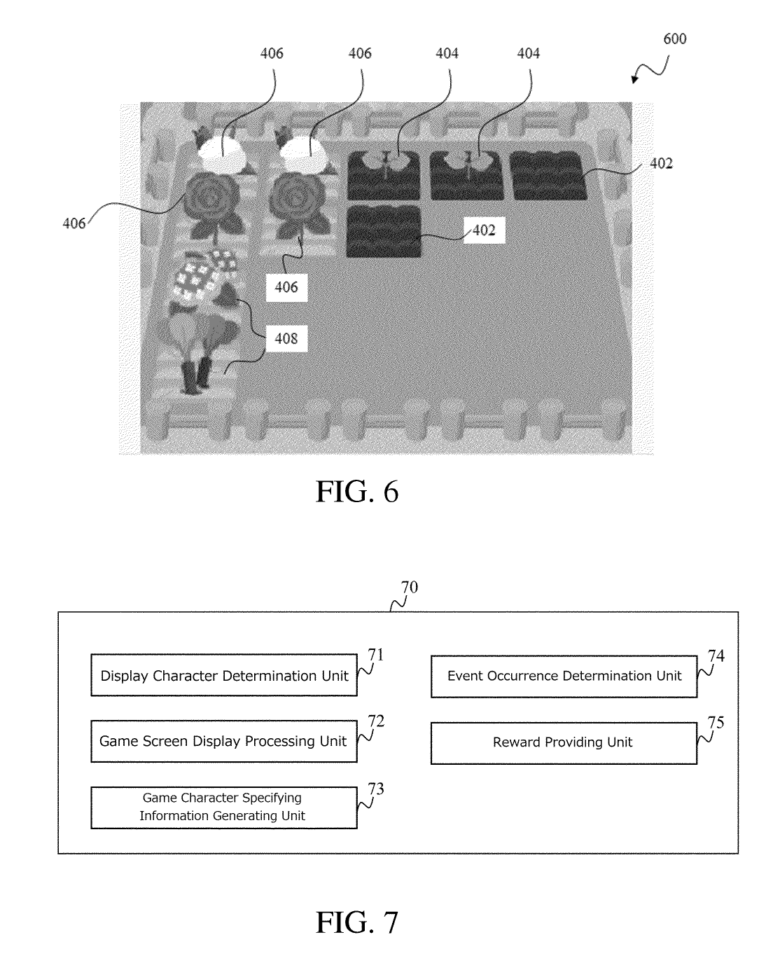

First, when the game is started in step 502, the player A operates a client device 30 to access the server device 10 and acquires a certain web page from a plurality of web pages constituting the game site. Ordinarily, the top page or the login screen of the game site is displayed When the player logs in the game, the game information of the player A at the time of the previous logout is read out from the external memory 15 to generate, based on the game information, HTML data for displaying a game screen at the time of the previous logout. The HTML data is provided to a client device 30. The client device 30 analyzes the obtained HTML data to generate a display screen, and displays the generated display screen on the display. FIG. 6 shows an example of a game screen displayed on the client device 30 after login. The game screen shown in FIG. 6 does not contain a game character; but if a game character is present at the time of the previous logout, the game character can remain on the screen.

Next, in step 504, the display character determination unit 52 determines a game character to be displayed in the game screen of the player A. Simultaneously, the display character determination unit 52 may determine whether a certain condition for displaying the game character is satisfied (e.g., whether a crop is harvestable, or whether the crop is a specific crop). Further, the display character determination unit 52 may determine whether to display the game character, either only once at the timing when the seedling grows and becomes harvestable or periodically (e.g., every ten minutes). In this embodiment, the display character determination unit 52 determines to display game characters 410 and 412 in the section 408. Next, in step 506, the display data providing unit 53 provides display data for displaying the determined game characters to the client device 30 of the player A. This display data includes information specifying the bottom left section of the farm and the section on top of the bottom left section where the game characters are to be displayed, and identification information for identifying the game characters to be displayed in the regions.

The client device 30 that obtained the display data displays the game character 412 in the bottom left section of the farm of the player A and displays the game character 410 in the section on top of the bottom left section in accordance with the display data. One or both of the game characters 410, 412 displayed on the client device 30 are selected by the player A; and when the selection is confirmed, game character specifying information including identification information for identifying a player character is generated. In this description, it is assumed that both game characters 410, 412 are selected. The game character specifying information includes identification information for identifying the game character 410 and identification information for identifying the game character 412.

The game character specifying information thus generated is sent to the server device 10 along with an event determination request. When a game item is selected by the player, game item identification information for identifying the game item is also included in the event determination request. In step 508, if the event determination request from the client device 30 is received by the receiving unit 54 of the server device 10, the process proceeds to step 510. On the other hand, if the game characters displayed on the client device 30 are not selected within a predetermined period of time, the process returns to step 504 where display characters are determined again. In the example shown in FIG. 4, it is determined in step 504 to display a game character in any of the sections 406 where no game character is displayed.

In step 510, it is determined whether a certain event (e.g., capture) occurs to each of the game character 410 and the game character 412 specified by the game character specifying information included in the event determination request received by the receiving unit 54. Next, in step 512, it is determined whether a predetermined reward-providing condition has been satisfied, based on the determination result in step 510. Examples of the reward-providing conditions have been described above. For example, a reward-providing condition is satisfied if it is determined that a capture event occurs to both the game character 410 and the game character 412. When the reward-providing condition is satisfied, the process proceeds to step 514 and the player A is provided with a certain reward. When the player A is provided with the certain reward, the process proceeds to step 516. If it is determined in step 512 that the reward-providing condition is not satisfied, the player A is not provided with a reward; and the process proceeds to step 516.

Next, in step 516, if the player A does not terminate the game, the process returns to step 504 where display characters are determined again. If the player A terminates the game, the game is terminated with respect to the player A.

As described above, in the embodiment of the present invention, a player is provided with a reward if it is determined that a certain event occurs to two or more of the specific game characters selected by the player; therefore, the player can take various strategies for acquiring a reward. That is, in the embodiment of the present invention, the possibility of acquiring a reward increases as the number of game characters selected by the player increases; therefore, strategic judgment is required in deciding the number of game characters to be selected as compared to conventional games. Accordingly, the strategies for acquiring a reward can be enhanced in games wherein a player is provided with a reward when a certain event occurs in accordance with the operation by the player on a game character. Additionally, since the event occurrence possibility can be varied in accordance with the game item selected by the player, strategic judgments are required in deciding which game item to use (or not to use) as well as in deciding the number of game characters to be selected. Thus, the embodiments of the present invention provide server devices and game programs that can enhance the strategies for acquiring a reward in games wherein a player is provided with a reward when a certain event occurs in accordance with the operation by the player on a game character.

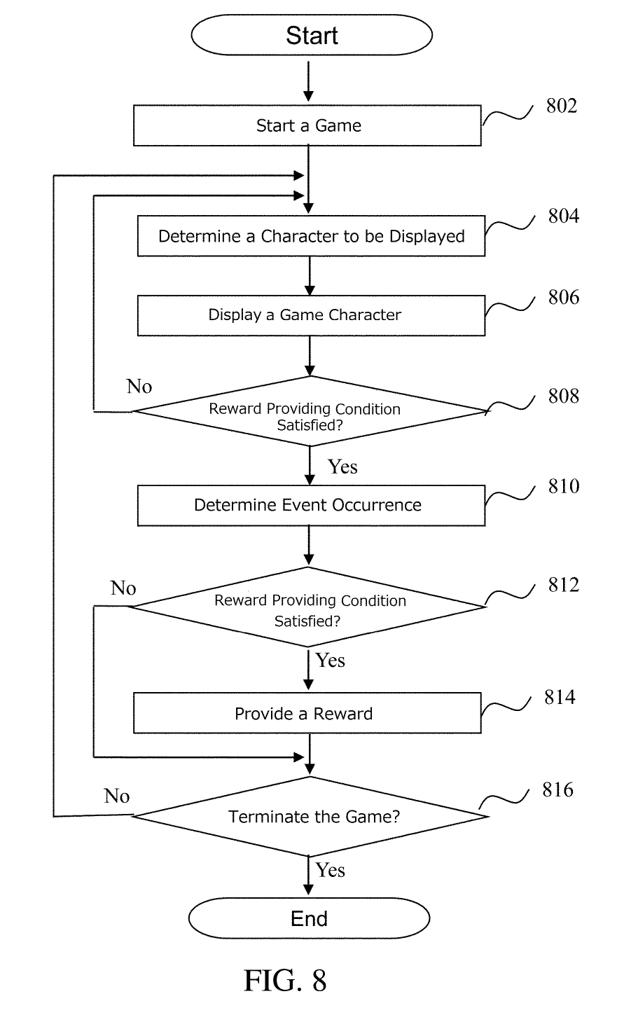

Next, a client device according to another embodiment of the present invention will be described below with reference to FIGS. 7 and 8. FIG. 7 is a block diagram illustrating the functionality of a client device according to the other embodiment of the present invention; and FIG. 8 is a flow diagram schematically illustrating the process of providing a reward to a player performed in the client device of FIG. 7. The hardware configuration of the client device 70 shown in FIG. 7 is generally the same as that explained in FIG. 2 and the detailed descriptions corresponding to FIG. 2. The client device 70 is connected to the server device for providing games via a network as is the client device 30.

As shown in FIG. 7, the client device 70 according to the other embodiment of the present invention comprises: a display character determination unit 71; a game screen display processing unit 72; a game character specifying information generating unit 73; an event occurrence determination unit 74; and a reward-providing unit 75. These functions may be implemented as, for example, functions of game applications executed on the client device 70 or functions of a platform executing the game applications. The client device 70 may comprise desired functions required for progressing a game, in addition to those shown in FIG. 7; detailed description is omitted for these functions. Also, part of the functions shown in FIG. 7 may be omitted as desired

The display character determination unit 71 determines one or more game characters to be displayed in the game screen, as does the display character determination unit 52 described above. The game screen display processing unit 72 generates a game screen including the one or more game characters determined by the display character determination unit 71 and displays the game screen on the display of the client device 70. The displayed game screen is the same as those shown in FIG. 4 and FIG. 6.

When the player selects one or more game characters from the displayed game screen, the game character specifying information generating unit 73 generates game character specifying information for specifying the selected one or more specific game characters. When the game character specifying information generating unit 73 has generated game character specifying information, the event occurrence determination unit 74 determines whether an event (e.g., capture) occurs to each of the specific game characters specified by the game character specifying information. The specific method of determining whether an event occurs is generally the same as that performed by the event occurrence determination unit 55. A reward-providing unit 75 determines whether a predetermined reward-providing condition is satisfied in accordance with the result of determination made by the event occurrence determination unit 74 and, when the conditions are satisfied, the reward-providing unit 75 provides a reward to the player. The specific method of determination and the specific method of providing a reward performed by the reward-providing unit 75 are generally the same as the functions of the reward-providing unit 56.

Next, an example of reward-providing process in the other embodiment of the present invention will be described below with reference to FIG. 8. FIG. 8 is a flow diagram schematically showing the process from the start of the game to the determination of a reward provided to the player. In this embodiment, description will be made for the case where the client device 70 performs a farm simulation game.

First, the game is started in step 802. The client device 70 displays, for example, a start screen or a login screen of the game read out from an external memory 35. When the player logs in the game, the game information at the time of the previous logout is read out from the external memory 35 to generate, based on the game information, a display screen as shown in FIG. 6 for example.

Next, in step 804, the display character determination unit 71 determines a game character to be displayed in the game screen. Simultaneously, the display character determination unit 71 may determine whether a certain condition for displaying a game character is satisfied (e.g., whether a crop is harvestable, or whether the crop is a specific crop). Further, the display character determination unit 71 may determine whether to display the game character, either only once at the timing when the seedling grows and becomes harvestable or periodically (e.g., every ten minutes). Next, in step 806, the game character determined in step 804 is displayed on the client device 70. For example, as shown in FIG. 4, game characters 410, 412 are displayed in the section 408 in the game screen. When one or both of the game characters 410, 412 displayed on the client device 70 are selected by the player A, game character specifying information including identification information for identifying the selected player character (a specific player character) is generated. In the following description, it is assumed that both the game character 410 and the game character 412 are selected by the player. If the game character specifying information is generated in step 808, the process proceeds to step 810. On the other hand, if the game character specifying information is not generated within a predetermined period of time, the process returns to step 804 where display characters are determined again.

In step 810, it is determined whether a certain event (e.g., capture) occurs to each of the game characters 410 and the game character 412 specified by the generated game character specifying information. Next, in step 812, it is determined whether a predetermined reward-providing condition has been satisfied, based on the determination result in step 810. Examples of the reward-providing conditions have been described above. For example, a reward-providing condition is satisfied if it is determined that a capture event occurs to both the game character 410 and the game character 412. When the reward-providing condition is satisfied, the process proceeds to step 814, and the player is provided with a certain reward. The provided reward may be stored in the external memory 35. In another example, the reward provided to the player may be sent to the server device along with the player identification information of the player and managed by the server device.

When the player is provided with the reward, the process proceeds to step 816. If it is determined in step 812 that the reward-providing condition is not satisfied, the player A is not provided with a reward; and the process proceeds to step 816. Next, in step 816, if the player does not terminate the game, the process returns to step 804 where display characters are determined again. If the player terminates the game, the game is terminated.

As described above, in this embodiment, the strategies for acquiring a reward can be enhanced in games wherein a player is provided with a reward when a certain event occurs in accordance with the operation by the player on a game character.

Thus, the invention was explained based on the embodiments deemed to be the most practical and desirable at the moment, but these explanations are directed only to explanation of the present invention and are not intended to limit the present invention to the disclosed embodiments. The explanations made herein are intended to include modifications within the purport and scope of the claims made to any feature of the above described embodiments and equivalents thereof. For example, combinations of a feature of any of the above described embodiments with one or more features of another embodiment are included in the scope of the present invention as far as possible.

Part or all of the functions described herein as those of the server device may be implemented in another server device and/or client device. For example, as shown in FIG. 7, a function equivalent to the display character determination unit 52 of the server device 10 may be implemented in a client device. Similarly, part or all of the functions described herein as those of the client devices may be implemented in the server device.

The processes and procedures described and illustrated herein may be implemented by software, hardware, or any combination thereof, as well as those explicitly stated in the embodiments. More specifically, the processes and procedures described and illustrated herein are implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

The processes and procedures described and illustrated herein to be executed by a single device, software piece, component, or module may also be executed by a plurality of devices, a plurality of pieces of software, a plurality of components, and/or a plurality of modules. The data, table, or database described and illustrated herein to be stored in a single memory may also be distributed to and stored in a plurality of memories included in a single device or a plurality of memories which are located in a plurality of devices in a distributed manner. Furthermore, the elements of the software and hardware elements described and illustrated herein may also be integrated into a smaller number of constituent elements or separated into a larger number of constituent elements.

Even if it is herein described that the invention comprises one element or that the invention comprises a plurality of same elements, the invention may comprise either one element or a plurality of same elements, except when such description should be differently interpreted in the context.

The procedures described herein, particularly those described with a flowchart, are susceptible of omitting part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

What is claimed is:

1. A server device for providing a game to a client device via a network, comprising:
a display character determination unit configured to determine, in accordance with a satisfied appearance condition, one or more game characters to be displayed in a game screen displayed on the client device;
a receiving unit configured to receive an event determination request including game character specifying information for specifying one or more specific game characters selected, in accordance with an operation by a player on the client device, from one or more game characters included in the game screen displayed on the client device;
an event occurrence determination unit configured to determine, in response to receipt of the event determination request and based on predetermined probabilities, whether a certain event occurs to each of the one or more specific game characters specified by the game character specifying information; and
a reward-providing unit configured to determine whether a certain reward-providing condition is satisfied and, when determining that the certain reward-providing condition is satisfied, providing a reward to the player, the certain reward-providing condition at least encompassing a condition that it is determined that the event occurs to two or more of the specific game characters specified by the game character specifying information.

2. The server device of claim 1, wherein the event determination request includes game item identification information for identifying a game item affecting a determination result of the event occurrence determination unit, and wherein the predetermined probabilities are varied based at least on the game item identification information.

3. The server device of claim 1, wherein the certain reward-providing condition encompasses a condition based on an attribute of the game character to which the event is determined to occur.

4. The server device of claim 1, wherein the reward-providing unit is configured to determine a reward to be provided to the player based on an attribute of the game character to which the event is determined to occur.

5. The server device of claim 1, wherein the certain reward-providing condition encompasses a condition that an attribute of a first game character among two or more game characters to which the event is determined to occur satisfies a predetermined relationship with an attribute of a second game character among the two or more game characters.

6. The server device of claim 1, wherein the one or more game characters displayed in the game screen include an interaction game character generated based on one or more game characters provided from one or more players other than the player to the player, and wherein the certain reward-providing condition encompasses a condition that it is determined that the event occurs to two or more of the specific game characters specified by the game character specifying information.

7. A method of providing a game by using a computer, the method comprising the steps of:
determining a game character to be displayed in a game screen displayed on the computer in accordance with a satisfied occurrence condition;
causing the computer to display the game screen;
generating game character specifying information for specifying one or more specific game characters selected, in accordance with an operation by a player on the computer, from one or more game characters included in the game screen displayed on the computer;
in response to the generation of the game character specifying information, determining based on predetermined probabilities whether a certain event occurs to each of the one or more specific game characters specified by the game character specifying information; and
determining whether a certain reward-providing condition is satisfied and, when determining that the certain reward-providing condition is satisfied, providing a reward to the player, the certain reward-providing condition at least encompassing a condition that it is determined that the event occurs to two or more of the specific game characters specified by the game character specifying information.
